(19) United States
(12) Patent Application Publication
(10) Pub. No.: US 2011/0310757 A1
(43) Pub. Date: Dec. 22, 2011

(54) METHOD OF SELECTING A DESTINATION NODE, NODE AND RECORDING MEDIUM

(76) Inventors: Shogo Yokoyama, Tokyo (JP); Minoru Ohta, Tokyo (JP)

(21) Appl. No.: 13/148,898

(22) PCT Filed: Feb. 22, 2010
(86) PCT No.: PCT/JP2010/052615

§ 371 Date: Aug. 10, 2011

(30) Foreign Application Priority Data
Mar. 6, 2009 (JP) 2009-053457

(51) Int. Cl. H04L 12/26

(52) U.S. Cl. 370/252

(57) ABSTRACT

A monitoring node periodically transmits an active/inactive monitoring signal to selection target nodes. Upon receipt of the active/inactive monitoring signal, each selection target node calculates a current subscriber accommodated ratio, which is load information, creates an active/inactive monitoring response signal based on the load information, and transmits the active/inactive monitoring response signal to the monitoring node. Upon receipt of the active/inactive monitoring response signal from the selection target node, the monitoring node extracts the load information from the active/inactive monitoring response signal, determines the relevant acquisition ratio based on the load information, and performs the selection procedure of a destination node based on the determined acquisition ratio.

### TECHNICAL FIELD

The present invention relates to a method in which one node selects a destination node from a plurality of other nodes.

### BACKGROUND ART

A conventional method of selecting a destination node includes a round robin method, a priority method and a static ratio dispersal method.

Specific operation of the static ratio dispersal method that the present invention follows will be explained.

FIG. 1 is an explanatory view of a method of implementing selection of a node using the static ratio dispersal method. In FIG. 1, ratio 1 is set to node 2, ratio 2 is set to node 3, and ratio 2 is set to node 4. Node 1 selects nodes 2, 3 and 4 in this order as in the round robin method. In the second round, node 1 does not select node 2, but selects nodes 3 and 4. Thus, node 1 performs selection based on the ratio. When the ratio is satisfied, the selection logic is reiterated from the beginning.

As explained hereinabove, according to the static ratio dispersal method, a node is selected based on the initially set ratio with disregard to the load state of each node. Therefore, a substantial delay in processing may arise.

Since the round robin method, the priority method and the static ratio dispersal method all do not take into account loads of nodes, a node with a high load may be accessed without concern for the high load, thus causing a substantial delay in processing. Eventually, this results in degradation in processing ability of the entire system.

In order to solve this problem, there is proposed a method in which the load of each node is always checked by a system administrator, and when there is a node(s) having a high load, the setting is manually changed so that the node(s) is/are not selected. This necessitates constant checking of a high load node that may occur unexpectedly, imposing a significant burden on the system administrator.

Patent literature 1 discloses the ability of freely handling the dispersal ratio of traffic load in a packet communications network having a plurality of routes. Patent literature 2 discloses the ability of load dispersal according to the transfer capability of each communication path. Patent literature 3 discloses that information necessary for searching for an optimum route that takes into account load dispersal among nodes is collected, and the search for a relay circuit in a dynamic routine selection network is performed in accordance with the collected information.

Patent literature 1: JP07-115434A

Patent literature 2: JP09-027833A

Patent literature 3: JP1-032081A

### SUMMARY OF THE INVENTION

### Problems to be Solved by the Invention

It is an object of the present invention to remedy the aforementioned problem and to provide a dynamic destination node selection method that takes into account the load state of nodes.

### Means to Solve the Problems

The present invention follows a static load dispersal method which is a conventional node selection method, collects load information of nodes simultaneously with monitoring active/inactive of nodes, and dynamically changes the load dispersal ratio. This therefore does not impose a burden on the system administrator to constantly check the load states of nodes, thus suppressing the occurrence of delay in processing.

Load states of nodes of selection target are utilized when nodes are selected in accordance with the conventional static ratio dispersal method. When delay in processing is likely to occur in a selected note owing to failure, congestion and etc., the ratio for the node is lowered and the node is dropped from the node selection target. This makes it possible to select normal nodes alone without selecting nodes that have caused the problem of failure, congestion and etc., thus suppressing the occurrence of delay in processing.

### Effects of the Invention

The present invention operates to collect load information of nodes simultaneously with monitoring active/inactive of nodes when node selection is performed in accordance with the conventional static load dispersal method, and to dynamically change the load dispersal ratio. Therefore, a situation in which a single node is heavily loaded can be avoided. Furthermore, since the selection ratio is dynamically changed, loads of the entire system are dispersed even if the system administrator does not constantly check the load states of the nodes.

### BRIEF EXPLANATION OF THE DRAWINGS

FIG. 1 is an explanatory view of a conventional static ratio dispersal method.

FIG. 2 is a view illustrating the configuration of a system according to an exemplary embodiment of the invention.

FIG. 3 is a block diagram of node 1.

FIG. 4 is a block diagram of nodes 2 to 4.

FIG. 5 is a view illustrating the sequence of selecting a node.

FIG. 6 is a view illustrating the node selection principle according to the present invention.

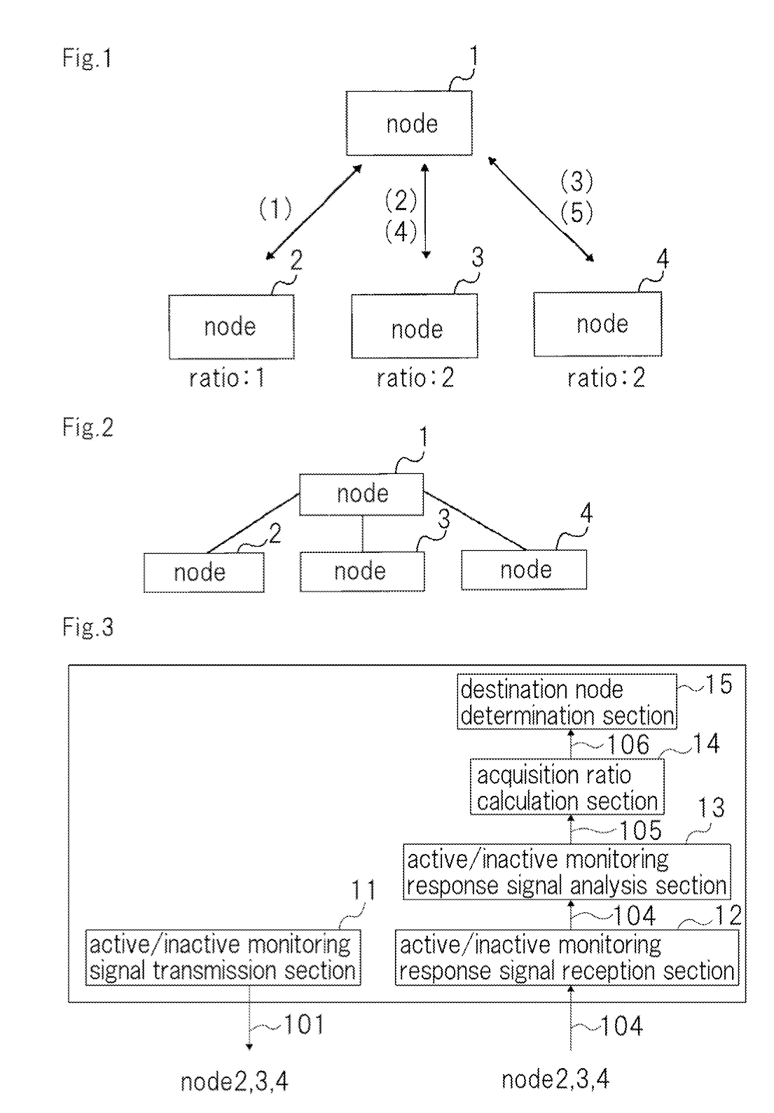

### EXPLANATION OF SYMBOLS

1˜4 node

11 active/inactive monitoring signal transmission section

12 active/inactive monitoring response signal reception section

13 active/inactive monitoring response signal analysis section

14 acquisition ratio calculation section

15 destination node determination section

21 active/inactive monitoring signal reception section

22 subscriber accommodated ratio calculation section

23 active/inactive response signal creation section

24 active/inactive response signal transmission section

101 active/inactive monitoring signal

102 load information calculation instruction

103 load information

104 active/inactive monitoring response signal

105 load information

106 acquisition ratio

201˜205 step

### BEST MODE FOR CARRYING OUT THE INVENTION

Exemplary embodiments of the present invention will now be described in detail with reference to the drawings.

Referring to FIG. 2, a system according to the exemplary embodiment comprises node 1 and nodes 2 to 4 that are to be connected to node 1. Node 1 is a monitoring node that periodically transmits active/inactive monitoring signal 101 to nodes 2 to 4; receives active/inactive monitoring response signal 104 that includes load information from nodes 2 to 4; determines a destination node to be connected, based on the load information; and performs connection processing of the determined destination node. Nodes 2 to 4 are nodes that receive active/inactive monitoring signal 101 that is periodically transmitted from monitoring node 1, and send back to monitoring node 1 active/inactive monitoring response signal 104 including load information. Nodes 2 to 3 are hereinafter collectively referred to as a connection target node.

FIG. 3 is a view illustrating the configuration of node 1. Node 1 comprises active/inactive monitoring signal transmission section 11, active/inactive monitoring response signal reception section 12, active/inactive monitoring response signal analysis section 13, acquisition ratio calculation section 14 and destination node determination section 15.

Active/inactive monitoring signal transmission section 11 periodically transmits active/inactive monitoring signal 101 to the connection target nodes. Active/inactive monitoring response signal reception section 12 receives active/inactive monitoring response signal 104 from the connection target nodes. Active/inactive monitoring response signal 104 is a response signal to active/inactive monitoring signal 101 that is periodically transmitted from monitoring node 1. Active/inactive monitoring response signal analysis section 13 analyses active/inactive monitoring response signal 104 and extracts load information 105 (subscriber accommodated ratio) therefrom. Acquisition ratio calculation section 14 holds therein ratio definition table of Table 1, and converts the load information to acquisition ratio information 106. Destination node determination section 15 periodically determines a destination node that is to be connected to monitoring node 1 from the connection target nodes based on acquisition ratio information 106.

[Table 1]

[symbol]

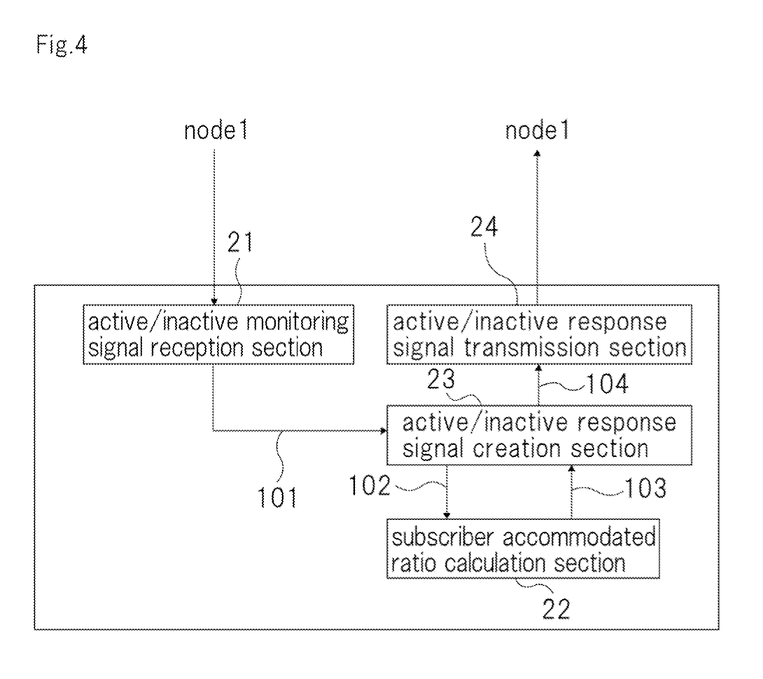

FIG. 4 is a view illustrating the configuration of the connection target nodes. The target node comprises active/inactive monitoring signal reception section 21, subscriber accommodated ratio calculation section 22, active/inactive monitoring response signal creation section 23, and active/inactive monitoring response signal transmission section 24. Active/inactive monitoring signal reception section 21 receives active/inactive monitoring signal 101 from monitoring node 1. Upon receipt of load information calculation instruction 102 from active/inactive monitoring response signal creation section 23, subscriber accommodated ratio calculation section 22 calculates the current load information 103 by dividing the number of subscribers whose positions have been registered by the time at which the active/inactive monitoring signal is received, by the maximum number of subscribers that can be accommodated in the node. Active/inactive monitoring response signal creation section 23 creates active/inactive monitoring response signal 104 to be sent back to node 1. Active/inactive monitoring response signal transmission section 24 transmits active/inactive monitoring response signal 104 to node 1.

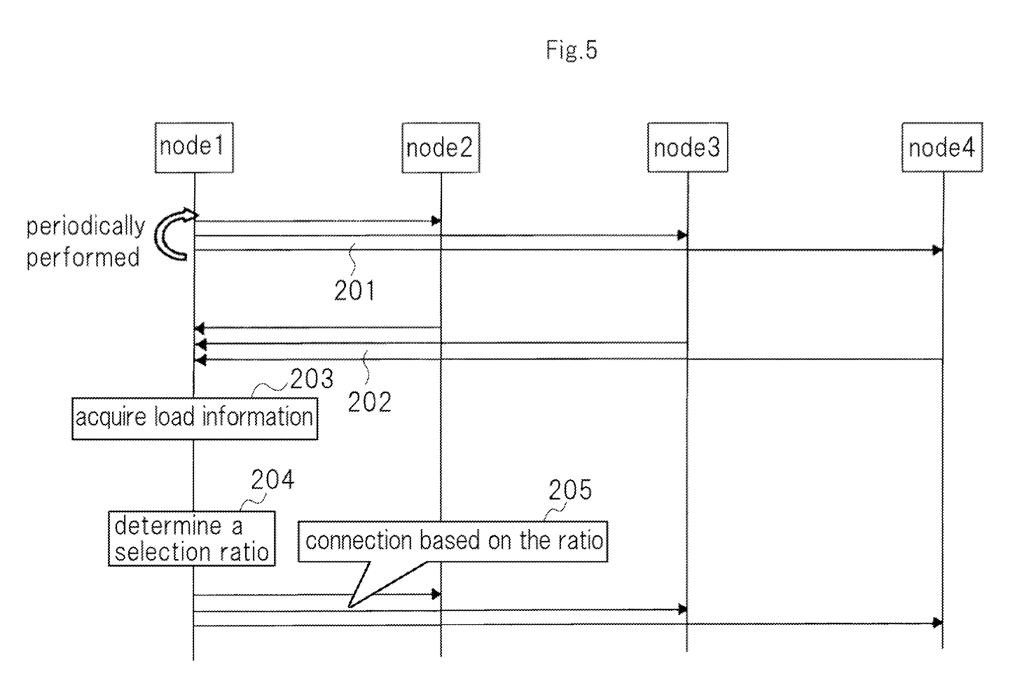

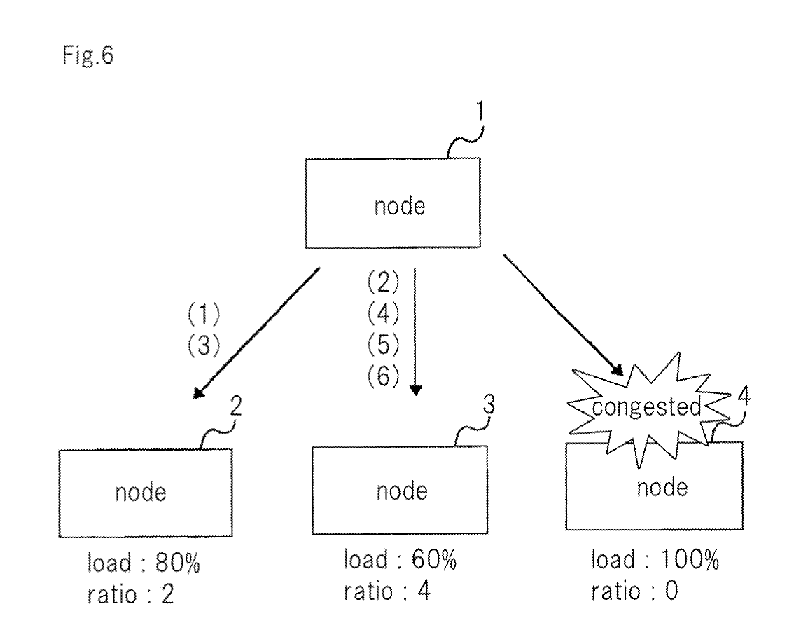

Operation of the present exemplary embodiment will now be described based on the sequence chart of FIG. 5 and the connection destination selection view of FIG. 6.

Please note that FIGS. 3 and 4 do not describe inherent functions of nodes 1 to 4 because they are not related to the present invention.

First, node 1 periodically transmits active/inactive monitoring signal 101 to nodes 2 to 3 to perform an active/inactive monitoring (step 201). Nodes 2 to 3 send back active/inactive monitoring response signal 104 to node 1, and at that time describe load information (subscriber accommodated ratio) within the signal (step 202). Node 1 collects the load information within received active/inactive monitoring response signal 104 (step 203). Dynamic change of the node selection ratio is performed based on this load information (subscriber accommodated ratio) (step 204). Node 1 comprises the ratio definition table of Table 1, and compares the load information with the ratio definition table to determine the acquisition ratio. The subscriber accommodated ratio is defined in ten steps with an increment of 10% such as 1˜10%, 11%˜20% . . . The lower the subscriber accommodated ratio, the lower is the current load. For the subscriber accommodated ratio of 91% to 100% from among the ten stages, the node can be judged to be congested so that the ratio is 0 and the node is eliminated from an object to be selected. The acquisition ratio is incremented by 1 to the maximum acquisition ratio of 9 from the node having a load such as 1 for the stage of 81% to 90%, 2 for the stage of 71% to 80%. The above ratio makes it possible for node 1, in the example shown in FIG. 6, to eliminate node 4 that is judged to be congested, and to select a node focusing around node 3 whose load is lower than other nodes (step 204). In the example of FIG. 6, the ratio for node 2 is assumed to be 2 because its load is 80%, the ratio for node 3 is assumed to be 4 because its load is 60%, and the ratio for node 4 is assumed to be 0 because its load is 100%. In such a situation, node 1 checks the ratio for node 2 to confirm that the ratio is 2 and the node can be selected, and first selects node 2. Subsequently, node 1 checks the ratio for node 3 to confirm that the ratio is 4 and the node can be selected, and selects node 3. Next, node 1 checks the ratio for node 4 to confirm that the ratio is 0, but judges that node 4 should not be selected and does not select node 4. Next, node 1 checks the ratio for first node 2, and selects node 2 second time. Subsequently, node 1 selects node 3. Node 4 is skipped because the ratio is 0, and control returns to node 2. At this time, the node to be selected is changed with the ratio. When looking at the entire system, it can be seen that the ratio for node 2 is 2, the ratio for node 3 is 4, and the ratio for node 4 is 0. This indicates that when node 2 is selected two times, node 3 must be selected four times, and node 4 must be selected 0 times. Accordingly, node 1 skips node 2 and selects node 3 successively three times. At this time, nodes 2, 3 and 4 have been selected in accordance with respective ratios, control returns to the beginning.

By using such logic, nodes with high load can be avoided, reducing the load of the entire system. The load information is updated with an interval of 90 seconds, for example. Even if the selection is being performed, the selection ratio is not considered, but the updated ratio is used to resume the selection. This is explained using FIG. 6. For example, when four times selections are completed, node 3 must be selected for the remaining two times. When the load information is updated at this time, the information thus far selected is reset, and the selection is resumed from the beginning. Even in this case, the selection is performed while checking the ratio based on the load information. Therefore, it is possible to select a node while dealing with a change in the load information, still rendering the load distribution of the entire system possible.

Next, description will be given of how node 1 and selection target nodes operate, using FIGS. 3 and 4. Node 1 periodically transmits active/inactive monitoring signal 101 to selection target nodes from active/inactive monitoring signal transmission section 11. Thereafter, node 1 receives active/inactive monitoring response signal 104 from the selection target node at active/inactive monitoring response signal reception section 12. Active/inactive monitoring response signal 104 received at active/inactive monitoring response signal reception section 12 is then delivered to active/inactive monitoring response signal analysis section 13. Active/inactive monitoring response signal analysis section 13 extracts load information 105 necessary for calculating the acquisition ratio from active/inactive monitoring response signal 104. Extracted load information 105 is delivered to acquisition ratio calculation section 14. Acquisition ratio calculation section 14 compares the delivered load information 105 with the ratio definition table of Table 1 to determine relevant acquisition ratio 106. Determined acquisition ratio 106 is delivered to destination node determination section 15. Destination node determination section IS performs the selection procedure of a destination node based on delivered acquisition ratio 106.

A selection target node receives active/inactive monitoring signal 101 from node 1 at active/inactive monitoring signal reception section 21. Upon receipt of active/inactive monitoring signal 101, in order to make a response to active/inactive monitoring signal 101, active/inactive monitoring signal reception section 21 instructs active/inactive response signal creation section 23 to send a reply. In order to bear load information on active/inactive monitoring response signal 104, active/inactive response signal creation section 23 issues instruction 102 to subscriber accommodated ratio calculation section 22 to calculate a subscriber accommodated ratio. Subscriber accommodated ratio calculation section 22, which has been instructed to calculate a subscriber accommodated ratio, divides the number of position-registered subscribers at the present time by the maximum number of accommodated subscribers which is set for the selection target node to calculate the subscriber accommodated ratio (load information) 103 in 10% unit. Calculated load information 103 is notified to active/inactive response signal creation section 23. Active/inactive response signal creation section 23 creates active/inactive monitoring response signal 104 based on notified load information 103. Load information 104 is set as “X-Registration-Control: 80; target=sip:10.4.88.244”, for example, by defining a unique header (X-Registration-Control), where “80” represents a subscriber accommodated ratio, and “target=sip:10.4.88.244” represents a notified party. The created signal is delivered to active/inactive response signal transmission section 24 in order to be transmitted to node 1. Active/inactive response signal transmission section 24 transmits delivered active/inactive monitoring response signal 104 to node 1. By holing information for the calculation of the selection ratio on active/inactive monitoring response signal 104, the increase of a network usage ratio of the entire system can be more efficiently avoided than by newly issuing a signal dedicated to the information for the calculation.

Other exemplary embodiments of the present invention will now be described.

The load information is not collected at the time of the active/inactive monitoring, but may be collected during exchange of other signals.

When there are additional nodes that are connected to nodes 2 to 4, logic to select these additional nodes is the same as the aforementioned logic.

The number of the selection target nodes is arbitrary.

The functions of nodes 1 to 4 may be carried out by recording a program for performing these functions in a computer-readable recording medium, reading the program recorded in the recording medium into a computer. The computer-readable recording medium may refer to recording medium such as flexible disk, a magneto-optical disk, CD-ROM and the like, and storage devices such as a hard disk drive incorporated in a computer system and the like. The computer-readable recording medium may also refer to a medium for dynamically holding a program for a short period of time (transmission medium or transmission wave) for use in applications for transmitting a program through the Internet, or a medium for holding the program for a certain period of time, e.g., a volatile memory in a computer system which operates as a server in such an application.

Although the preferred embodiments of present invention have been described using specific terminology, such descriptions are made only for purposes of illustration, and it should be understood that various changes and modifications can be made without departing from the appended claims.

This application claims the benefit of priority based on Japanese Patent Application No. 2009-053457 filed on Mar. 6, 2009, the entire disclosure of which is hereby incorporated by reference.

1. In a system comprising a first node and a plurality of second nodes which are selectively connected to said first node, a method of selecting a node/nodes to be connected to said first node, from said plurality of second nodes, said method comprising:
collecting load information that is a subscriber accommodated ratio of each second node;
determining an acquisition ratio of each second node from said load information, and
selecting a node/nodes to be connected to said first node, from among said plurality of second nodes based on the determined acquisition ratio.

2. The method according to claim 1, wherein the collection of said load information is performed at the time of the active/inactive monitoring of said plurality of second nodes.

3. The method according to claim 1, wherein the collection of said load information is periodically performed.

4. The method according to claim 1, wherein said acquisition ratio is determined using a ratio definition table that represents the relationship between the subscriber accommodated ratio and the acquisition ratio.

5. The method according to claim 1, wherein said load information is set using a unique header (X-Registration-Control).

6. In a system comprising a first node and a plurality of second nodes which are selectively connected to said first node, said first node comprising:
means that collects load information from said plurality of second nodes, said load information representing a subscriber accommodated ratio of the second node in question;
means that converts said load information into acquisition ratio information of the second node in question; and
means that selects a node/nodes to be connected to said first node from among said plurality of second nodes based on said acquisition ratio information.

7. The node according to claim 6, wherein said means that collects load information collects said load information by transmitting an active/inactive monitoring signal to said plurality of second nodes, and by receiving an active/inactive monitoring response signal from said plurality of second nodes, said active/inactive monitoring response signal being a response signal to said active/inactive monitoring signal.

8. The node according to claim 6, wherein said means that collects load information periodically collects said load information.

9. The method according to claim 6, wherein said means that converts said load information into acquisition ratio information, converts said load information into acquisition ratio information using a ratio definition table that represents the relationship between the subscriber accommodated ratio and the acquisition ratio.

10. In a system comprising a first node and a plurality of second nodes which are selectively connected to said first node, said each second A node comprising:
means that calculates load information that is the current subscriber accommodated ratio, in accordance with an instruction from said first node; and
means that transmits a signal including said load information to said first node.

11. A non-transitory computer readable recording medium storing a program incorporated in a first node to which a plurality of second nodes are selectively connected, wherein said program causes a computer to perform the procedures of:
transmitting an active/inactive monitoring signal to said plurality of second nodes;
receiving an active/inactive monitoring response signal from said plurality of second nodes, which is a response signal to said active/inactive monitoring signal;
analyzing said active/inactive monitoring response signal, and extracting load information therefrom which is a subscriber accommodated ratio of the second node in question;
converting said load information into acquisition ratio information of the second node in question; and
selecting a node/nodes to be connected to said first node from among said plurality of second nodes based on said acquisition ratio information.

12. A non-transitory computer readable recording medium storing a program incorporated in each of a plurality of second nodes which are selectively connected to a first node, wherein said program causes causing a computer to perform the procedures of:
receiving an active/inactive monitoring signal that is periodically transmitted from said first node;
calculating load information which is a current subscriber accommodated ratio;
creating an active/inactive monitoring response signal which is a response signal to said active/inactive monitoring signal and which contains said load information; and
transmitting said active/inactive monitoring response signal to said first node.
